(19) United States
(12) Patent Application Publication
(10) Pub. No.: US 2010/0200260 A1
(43) Pub. Date: Aug. 12, 2010

(54) HANDHELD TOOL

(75) Inventors: Mitsugu Mikami, Tokyo (JP); Yoshiaki Adachi, Tokyo (JP); Kouji Katou, Tokyo (JP); Kigen Agehara, Tokyo (JP); Takashi Miida, Tokyo (JP)

Correspondence Address: DRINKER BIDDLE & REATH (DC), 1500 K STREET, N.W., SUITE 1100, WASHINGTON, DC, 20005-1209, US

(73) Assignee: MAX CO., LTD., Tokyo (JP)

(21) Appl. No.: 12/439,768

(22) PCT Filed: Sep. 11, 2007
(86) PCT No.: PCT/JP2007/067661

§ 371 Date: Mar. 3, 2009

(30) Foreign Application Priority Data
Sep. 15, 2006 (JP) 2006-250772

(51) Int. Cl. B25B 21/00; B25F 5/00

(52) U.S. Cl. 173/176; 173/47; 173/217; 173/218

(57) ABSTRACT

A handheld tool includes a first power source, a second power source having a characteristic different from a characteristic of the first power source, and an operation part which is operated by a power from at least one of the first power source and the second power source to fasten a fastener.

### TECHNICAL FIELD

The present invention relates to a handheld tool for fasteners, e.g., for rotating and screwing a screw or for striking a nail.

### BACKGROUND ART

In recent years, in order to deal with variety of building construction techniques, various kinds of fasteners are demanded. For example, exterior heat insulation technique is recently attracting attention. In this technique, large wood screws having a length of 150 mm to 200 mm are used to fix heat insulating material onto the exterior. As for the handheld tools for fastening the wood screws, air impact drivers (see JP 2003-326473 A) and electric drills are known.

Air impact drivers are mounted with an air motor capable of obtaining a high torque, and electric drills are mounted with a high-speed electric motor. When fastening the large wood screws, it is required to rotate the wood screw at a high speed to screw the wood screw. Accordingly, the air impact drivers, which is driven by an air motor and is capable of obtaining a high torque, is usually used.

In a case of fastening the large wood screws having a length of 100 mm or more are with the air impact drivers, the wood screw can be fastened at the high torque. However, in order to obtain power that is required for the air motor to generate the high torque, a large amount of compressed air of about 40 liters is consumed just for rotating and screwing a single wood screw. When the consumption amount of the compressed air is large, the pressure of an air compressor for supplying the compressed air decreases remarkably. Therefore, there is a problem that the fastening operation cannot be continuously performed.

On the other hand, in a case of rotating and fastening the large wood screws using an electric motor, a load on the electric motor is large because a high screwing torque is required. Accordingly, the motors that are practically usable in view of handiness of the electric drills are likely to be damaged.

Like the example described above, when striking or rotating and screwing an unconventional fastener into a target member, handheld tools are required to be adapted to such fasteners.

### DISCLOSURE OF INVENTION

One or more embodiments of the present invention provide a handheld tool capable of being efficiently used in accordance with a type of work and a level of load.

According to one or more embodiments of the invention, a handheld tool includes a first power source, a second power source having a characteristic different from a characteristic of the first power source, and an operation part which is operated by a power from at least one of the first power source and the second power source to fasten a fastener.

According to one or more embodiments of the invention, the handheld tool may further include a power switching unit through which the power is transmittable between the first power source and the second power source.

According to one or more embodiments of the invention, the power switching unit may be operable to shut off a power transmission between the first power source and the second power source.

According to one or more embodiments of the invention, the handheld tool may further include a control circuit which controls the first power source and the second power source to drive at least one of the first power source and the second power source.

According to one or more embodiments of the invention, the handheld tool may further include a setting switch operable to set at least one of a timing at which the first power source is driven and a timing at which the second power source is driven. In such a case, the control circuit drives at least one of the first power source and the second power source, based on at least one of the timing at which the first power source is driven and the timing at which the second power source is driven which is set by the setting switch.

According to one or more embodiments of the invention, the first power source may be an electric motor which is driven by an electric power, and the second power source may be an air motor which is driven by a compressed air. In such a case, the operation part is rotated by the power from at least one of the electric motor and the air motor to rotate and to fasten the fastener.

According to one or more embodiments of the invention, the handheld tool may further include a sensor which detects a current value of the electric motor. In such a case, when the current value detected by the sensor reaches a certain value, the control circuit stops the electric motor and drives the air motor.

According to one or more embodiments of the invention, the handheld tool may further include a sensor which detects the number of rotations of the electric motor. In such a case, when the number of rotations detected by the sensor reaches a certain number of rotations, the control circuit stops the electric motor and drives the air motor.

According to one or more embodiments of the invention, the handheld tool may further include an air supply path through which the compressed air is supplied to the air motor, an air exhaust path through which an exhaust air from the air motor is exhausted, and an air cooling path which is branched from the air exhaust path and is arranged along a side wall of the electric motor. In such a case, the electric motor is cooled by the exhaust air passing through the air cooling path.

According to one or more embodiments of the invention, the handheld tool includes power sources (e.g., the electric motor and the air motor) that are different in their characteristic. Therefore, the operation part (e.g., a driver bit) can be operated such that either or both of the power sources can make the best use of the their characteristics, depending on the types of work, e.g., rotating or striking the faster, and the level of load. Accordingly, a wide range of work can be efficiently performed.

### BRIEF DESCRIPTION OF THE DRAWINGS

FIG. 1 is a schematic view of an impact driver which is a handheld tool according to an embodiment of the present invention.

FIG. 2 is a block diagram of a control system of the impact driver.

FIG. 3 is an operational flowchart of the impact driver.

FIG. 4 is a block diagram of a control system of an impact driver according to another embodiment of the present invention.

### EXPLANATION OF REFERENCE NUMERALS

2 Air Motor
3 Electric Motor
4 Power Switching Mechanism

### BEST MODE FOR CARRYING OUT THE INVENTION

Hereinafter, embodiments of the present invention will be described in detail with reference to drawings.

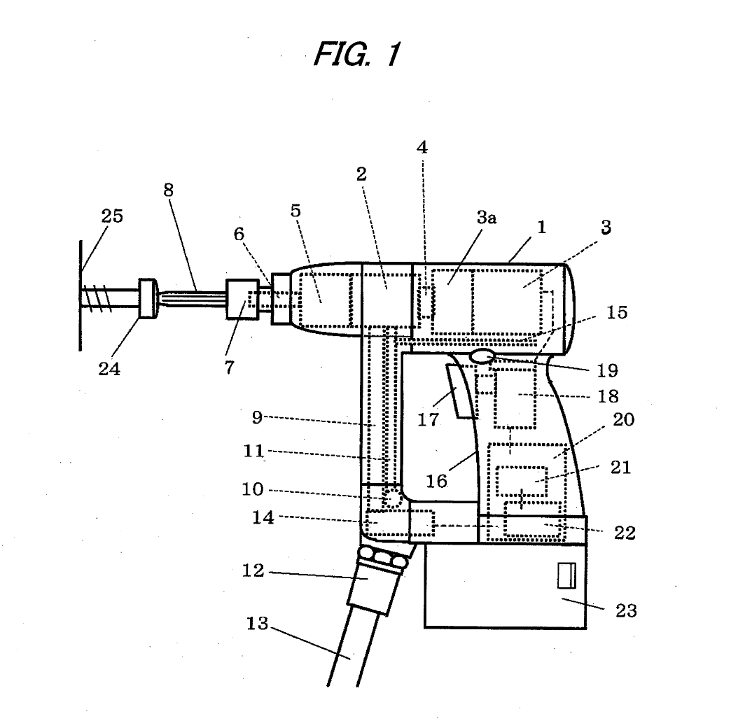

As shown in FIG. 1, an impact driver includes a tool body 1, an air motor 2 and an electric motor 3. The air motor 2 and the electric motor 3 are arranged inside the tool body 1. The air motor 2 and the electric motor 3 are serially arranged through a speed reduction mechanism 3a and a power switching mechanism 4. A strike generating mechanism 5 is provided on a front side of the air motor 2 to apply a striking force to a rotation of an output shaft 6 of the air motor 2. The output shaft 6 is forwardly protruded from the tool body 1, and a driver bit 8 (an operation part) is attached to the output shaft 6 via a bit holding sleeve 7.

An air supply path 9 for supplying compressed air to the air motor 2, and an air exhaust path 11 for exhausting the exhaust air from the air motor 2 to an exhaust port 10 are arranged in a lower front portion of the tool body 1. The air supply path 9 includes two path sections for forward rotation and reverse rotation of the air motor 2. An air coupler 12 is attached to the air supply path 9, and the air supply path 9 is coupled to an air hose 13 via the air coupler 12. An end portion of the air hose 13 is coupled to an air supply source such as an air compressor. An electromagnetic valve 14 is provided at a base portion of the air supply path 9. The electromagnetic valve 14 opens and closes, respectively, the two path sections of the air supply path 9 for forward rotation and reverse rotation of the air motor 2.

An air cooling path 15 branched from an intermediate portion of the air exhaust path 11. The air cooling path 15 is arranged along a side wall of the electric motor 3.

At a lower back portion of the tool body 1, a grip 16 is continuously formed. A motor operating trigger 17 is disposed on a front side of the grip 16. At an upper portion of the grip 16, an operational switch 18 which interlocks with the operation of the trigger 17, and a forward/reverse rotation selecting switch 19 for forwardly or reversely rotating the air motor 2 are provided. The forward/reverse rotation selecting switch 19 can be operated from outside.

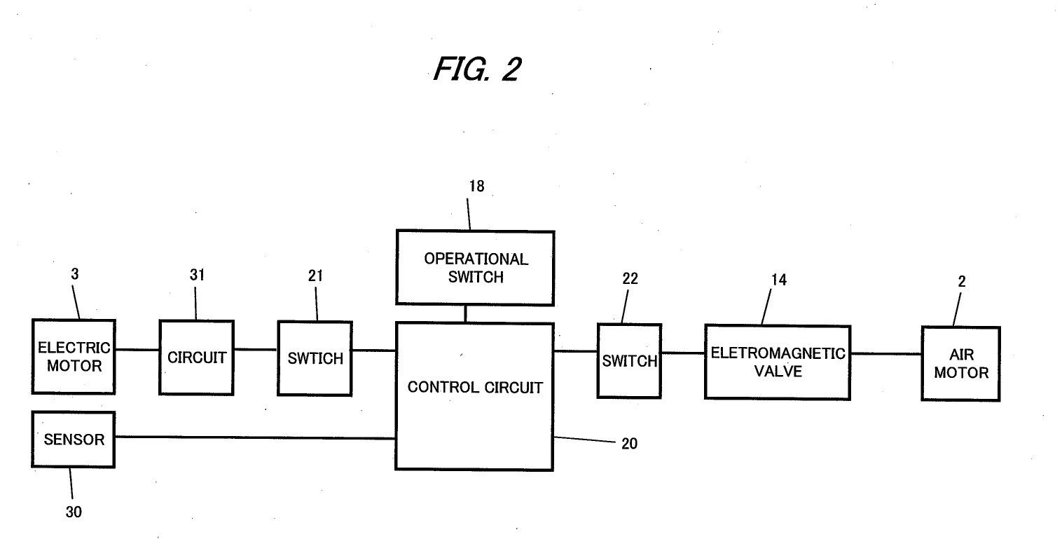

As shown in FIGS. 1 and 2, a motor control circuit 20 is disposed inside the grip 16. A switch 21 and a switch 22 are provided on the control circuit 20. As will be described later, the switch 21 closes or opens a power supply circuit 31 based on a detection of the number of rotations of the electric motor 3 or a load current. More specifically, when the number of rotations of the electric motor 3 or a detected value of the load current reaches a certain value, the switch 21 opens the circuit 31 to stop the electric power supply to the electric motor 3. The switch 22 is operated in accordance with the switch 21 such that the switch 22 closes the electromagnetic valve 14 when the switch 21 is turned on and opens the electromagnetic valve 14 when the switch 21 is turned off. On a lower side of the grip 16, a rechargeable battery 23 is provided as a power source.

Next, switching of the power of the impact driver, that is, switching of the air motor 2 and the electric motor 3 will be described.

The electric motor 3 has a smooth rotation rising characteristic, and the air motor 2 has a characteristic suitable for high speed and high torque. When rotating a wood screw 24 to screw it into a wood material 25, it is preferable that the wood screw 24 is rotated at a comparatively slow speed at the initial stage of screwing, and thereafter rotated at a high speed to be fastened. Thus, according to an embodiment of the present invention, the impact driver is set such that the electric motor 3 is firstly used to screw the wood screw 24 and then switches to the air motor 2. The air motor 2 and the electric motor 3 are coupled through the power switching mechanism 4, and the powers of the two motors are switched by the power switching mechanism 4. The power switching mechanism 4 may utilize one-way power transmission using a one-way clutch, or an idling mode of a planetary gear unit.

If the electric motor 3 is driven in accordance with the actuation of the air motor 2, the electric motor 3 becomes a generator, creating a load on the air motor 2. Therefore, when actuating the air motor 2, the power transmission between the two motors is shut off by the power switching mechanism 4, so that the load on the air motor 2 is reduced. When driving the tool using only the electric motor 3, the air motor 2 and the electric motor 3 are directly coupled by the power switching mechanism 4 (such as a planetary gear unit or a one-way clutch). In this case, a rotor of the air motor 2 rotates together, but the air motor 2 merely idles. Accordingly, the air motor 2 does not become a rotational load on the electric motor 3.

The load on the wood screw 42 increases as the wood screw 42 rotates and is gradually screwed into the wood material 25. Determination on how deep the wood screw 24 is screwed in order to switch the power from the electric motor 3 to the air motor 2 is based on a result of torque or the number of rotations of the output shaft 6 which may be estimated from information such as the number of rotations of the electric motor 3 or the load current. As shown in FIG. 2, the number of rotations of the electric motor 3 or the load current can be detected by providing a sensor 30. For example, in a case in which the sensor 30 is a rotation number detecting sensor that detects the number of rotations of the electric motor 3, the number of rotations of the electric motor 3 at the time when the load on the wood screw 24 reaches a certain load (i.e., at the time when the screwed amount of the wood screw 24 reaches a certain amount) may be obtained beforehand, so that the power can be switched when the sensor 30 detects a certain number of rotations. Alternatively, in a case in which the sensor 30 is a current detecting sensor that detects the load current on the electric motor 3, a current value of the electric motor 3 at the time when the load on the wood screw 24 reaches a certain load (i.e., at the time when the screwed amount of the wood screw 24 reaches a certain amount) mat be measured beforehand, so that the power can be switched when the sensor 30 detects the measured current value.

In the case of switching the power on the basis of the detection of the load current, at the time of starting the screwing, the switch 21 is turned on to close the circuit 31 which supplies electric power to the electric motor 3, and simultaneously, the switch 22 closes the electromagnetic valve 14. When the sensor 30 detects the certain current value, the switch 21 is turned off to disconnect the power supply circuit 31, and simultaneously, the switch 22 opens the electromagnetic valve 14 to supply compressed air to the air supply path 9, whereby the power is switched. In a light load work that does not require high torque (e.g., when inserting the wood screw 24 into a hole formed in a sash to secure the sash to a window frame), the screwing work is performed by using only the electric motor 3, and the air motor 2 is not actuated.

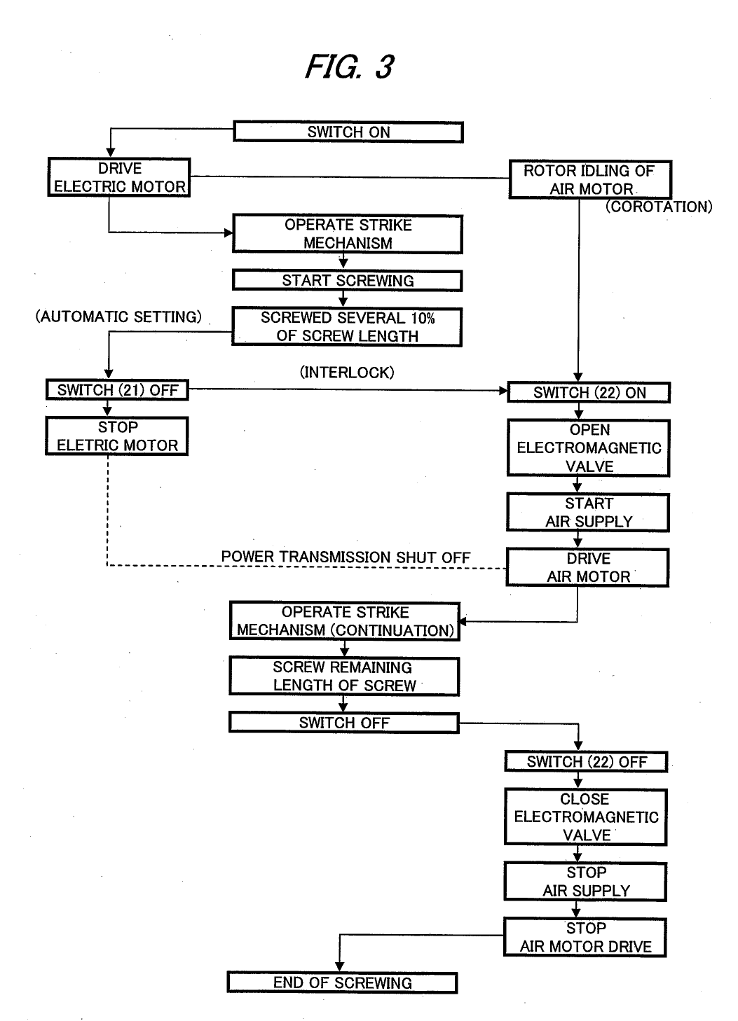

Next, operations of the impact driver according to an embodiment of the present invention will be described with reference to FIG. 3. First, a tip end of the driver bit 8 is engaged with a head groove of the wood screw 24, and the operational switch 18 is turned on to actuate the electric motor 3, whereby the driver bit 8 rotates together with the output shaft 6 of the electric motor 3. Next, the strike generating mechanism 5 is operated to start the screw-fastening. Because a large torque is not required in the initial stage of the screwing, the wood screw 24 reliably enters into the wood material 25. As the screwing advances, the load on the wood screw 24 gradually increases (i.e., the required torque increases). Therefore, when the wood screw 24 is screwed into the wood material 25 by several tens % of the length of the wood screw 24 so that the certain number of rotations of the electric motor 3 (a certain screwed-amount of the wood screw 24) or the certain current value is detected, the switch 21 is automatically turned off and the switch 22 is turned on in response to the switch 21 to open the electromagnetic valve 14, whereby the rotation of the electric motor 3 is stopped and simultaneously the compressed air from the air supply source is supplied to the air motor 2 through the air supply path 9 to drive the air motor 2. When the electric motor 3 is stopped, the power transmission of the electric motor 3 is shut off by the power switching mechanism 4, and is switched to the operation of only the air motor 2. When the air motor 2 is driven, the strike generating mechanism 5 is also actuated so that the driver bit 8 screws the remaining portion of the wood screw 24 into the wood material 25 at a high torque with a striking and rotational force. When the screwed amount reaches a required amount, the operator operates the trigger 18 to turn off the operational switch 18. When the operational switch 18 is turned off, the switch 22 is automatically turned off to close the electromagnetic valve 14, whereby the supply of the compressed air is stopped so that the rotation of the air motor 2 stops. Accordingly, screw-fastening of the wood screw 24 is completed.

When the operator has noticed after starting the screwing operation that the screwing position is wrong, the wood screw 24 that has already been screwed needs to be reversely rotated to unfasten the wood screw. In such a case, the forward/reverse rotation selecting switch 19 is turned on, whereby the electromagnetic valve 14 for reverse rotation is opened so that the air motor 2 reversely rotates. When the air motor 2 reversely rotates, the electric motor 3 is also reversely rotated. However, the rotation of the electric motor 3 is not transmitted to the air motor 2 through the power switching mechanism 4. Accordingly, this operation is based on the driving of only the air motor 2.

The more the load applied onto the electric motor 3 is, the larger the amount of electric current flowing to the electric motor 3 becomes so that the electric motor 3 generates heat. On the other hand, the exhaust air of the air motor 2 is cooled due to adiabatic expansion during the decompression. Therefore, a part of the exhaust air that branched from the air exhaust path 11 and is disposed along the side wall of the electric motor 3, so that the electric motor 3 can be efficiently cooled.

According to the impact driver of an embodiment of the present invention, in a low-torque process during the early stage of screwing, screwing is performed by using the power of the electric motor 3 which is driven by the rechargeable battery, and when a high torque becomes necessary, the power is automatically switched to the power of the air motor 2. Accordingly, it is possible to suppress the consumption amount of the compressed air, so that a continuous striking becomes possible even with the large wood screws.

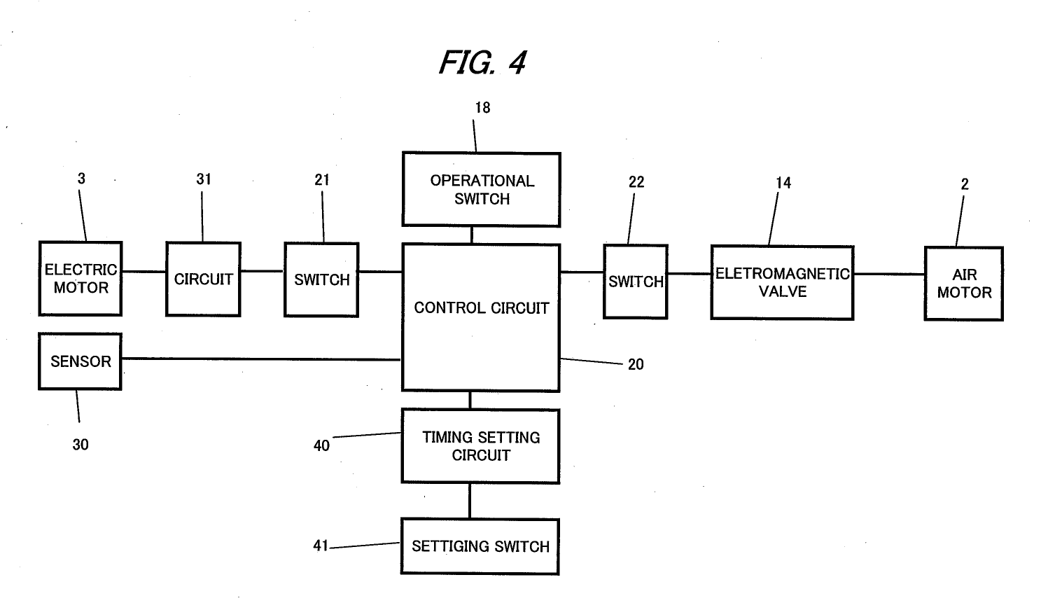

In the operational flow shown in FIG. 3, the electric motor 3 and the air motor 2 are selectively switched and actuated in accordance with their characteristics. As shown in FIG. 4, according to another embodiment of the present invention, the impact driver includes a timing setting circuit 40 which sets the on and off timings of the switches 21, 22 for starting and stopping the respective motors, and a setting switch 41. Depending on the timing of switching the power, the air motor 2 may be used as a main power source and the electric motor 3 may be used as a sub power source. To the contrary, the air motor 2 may be set as a sub power source and the electric motor 3 may be set as a main power source. Further, only one of the motors may set to be actuated.

For example, by operating the setting switch 41, a function of using only the electric motor 3 to complete the screw fastening may be selected (in case of a short and light load screw), or a function screw-fastening using only the air motor 2 may be selected, depending on the length of the screw. Like this example, because the driving of the electric motor 3 and the driving of the air motor 2 can optionally be set, it is possible to provide an impact driver that can used in a plurality of working conditions.

Further, the shafts of the electric motor 3 and the air motor 2 may be directed coupled without providing the power switching mechanism 4 to provide a parallel configuration in which a start-up g operation is controlled only by the smooth rotation of the electric motor 3, and when actuating the air motor 2, the torque of the air motor 2 is assisted by the electric motor 3. Like this example, working efficiency may be improved by simultaneously utilizing the characteristic of the electric motor 3 and the characteristic of the air motor 2.

Whether to switch to air motor 2 after driving the electric motor 3, whether to switch to the electric motor 2 after driving the air motor 2, and whether to employ a switching configuration or a parallel configuration between the electric motor 3 and the air motor 2, may be suitably selected, depending on types of operation, e.g. rotating or striking a fastener, and the level of the load.

While the handheld tools according to the embodiments described above are impact drivers having the actuating mechanism for rotating a wood screw, the present invention is also applicable to various handheld tools such as nailers, screw striking tools which fasten a screw after slightly striking the screw, drilling tools and the like.

While the present invention has been described in detail and with reference to specific embodiments thereof, it is apparent for those skilled in the art that various changes and modifications may be made therein without departing from the spirit and the scope of the present invention.

This application is based on Japanese Patent Application No. 2006-250772 filed on Sep. 15, 2006, the contents of which are incorporated herein by reference.

### INDUSTRIAL APPLICABILITY

The present invention provides a handheld tool that is capable of efficient work depending on the types of work and the level of load.

1. A handheld tool comprising:
a first power source;
a second power source having a characteristic different from a characteristic of the first power source; and
an operation part which is operated by a power from at least one of the first power source and the second power source to fasten a fastener.

2. The handheld tool according to claim 1, further comprising a power switching unit through which the power is transmittable between the first power source and the second power source.

3. The handheld tool according to claim 2, wherein the power switching unit is operable to shut off a power transmission between the first power source and the second power source.

4. The handheld tool according to claim 1, further comprising a control circuit which controls the first power source and the second power source to drive at least one of the first power source and the second power source.

5. The handheld tool according to claim 4, further comprising a setting switch operable to set at least one of a timing at which the first power source is driven and a timing at which the second power source is driven,
wherein the control circuit drives at least one of the first power source and the second power source, based on at least one of the timing at which the first power source is driven and the timing at which the second power source is driven which is set by the setting switch.

6. The handheld tool according to claim 1, wherein
the first power source comprises an electric motor which is driven by an electric power,
the second power source comprises an air motor which driven by a compressed air, and
the operation part is rotated by the power from at least one of the electric motor and the air motor to rotate and to fasten the fastener.

7. The handheld tool according to claim 6 further comprising a control circuit which controls the electric motor and the air motor to drive at least one of the electric motor and the air motor.

8. The handheld tool according to claim 7, further comprising a sensor which detects a current value of the electric motor,
wherein, when the current value detected by the sensor reaches a certain value, the control circuit stops the electric motor and drives the air motor.

9. The handheld tool according to claim 7, further comprising a sensor which detects the number of rotations of the electric motor,
wherein, when the number of rotations detected by the sensor reaches a certain number of rotations, the control circuit stops the electric motor and drives the air motor.

10. The handheld tool according to claim 7, further comprising a setting switch operable to set at least one of a timing at which the electric motor is driven and a timing at which the air motor is driven,
wherein the control circuit drives at least one of the electric motor and the air motor based on at least one of the timing at which the electric motor is driven and the timing at which the air motor is driven which is set by the setting switch.

11. The handheld tool according to claim 6, further comprising:
an air supply path through which the compressed air is supplied to the air motor;
an air exhaust path through which an exhaust air from the air motor is exhausted; and
an air cooling path which is branched from the air exhaust path and is arranged along a side wall of the electric motor,
wherein the electric motor is cooled by the exhaust air passing through the air cooling path.
